(19) United States
(12) Patent Application Publication
(10) Pub. No.: US 2015/0130231 A1
(43) Pub. Date: May 14, 2015

(54) VEHICLE SEAT ASSEMBLY WITH CHANGING STATION

(71) Applicant: Honda Motor Co., Ltd., Tokyo (JP)

(72) Inventors: Derek Shane Lindsay, Marysville, OH (US); Kristy A. Gilkerson, Marysville, OH (US); Suzanne S. Miller, Columbus, OH (US); Chad E. Harrison, Plain City, OH (US); Daric J. Galden, Plain City, OH (US)

(73) Assignee: Honda Motor Co., Ltd., Tokyo (JP)

(21) Appl. No.: 14/079,806

(22) Filed: Nov. 14, 2013

(51) Int. Cl. B60N 2/34

(52) U.S. Cl. CPC B60N 2/34
USPC 297/120; 297/125

(57) ABSTRACT

A vehicle includes a seat base and a folding seat back pivotally connected to the seat base. The folding seat back includes at least one of a contoured rear surface for retaining a child lying thereon when the seat back is folded onto the seat base in a fold-down position and a hinged panel pivotally attached to a rear side of the seat back that is moveable to an open position wherein an inner side of the hinged panel faces upward to provide an extended support surface for a child lying on the rear side of the seat back.

### BACKGROUND

When presently changing the diaper on a baby while traveling, one must remove the child from the vehicle to use a public restroom, change the child in a child seat disposed in the vehicle, change the child on the vehicle floor or on the seat base of a seat assembly or the like. None of these options is generally desirable. In particular, public restrooms can sometimes be unsanitary. Within the vehicle, it is often difficult to easily and cleanly change a baby's diaper due to the lack of a convenient surface and/or location. For example, changing the child on the vehicle floor may be difficult to access from inside or outside the vehicle. Changing a child on a cargo floor (e.g., in the back of a sport utility vehicle (SUV) may not feasible when carrying cargo in the vehicle. Finally, changing the child on the seat assembly may not be desirable because the child could potentially roll off the seat assembly and be harmed.

### SUMMARY

According to one aspect, a vehicle seat assembly includes a seat base and seat back pivotally connected to the seat base for movement between an upright position in which the seat base and seat back are configured for accommodating a seated occupant and a fold-down position wherein the seat back is folded down onto the seat base with a rear side of the seat back facing upward. The rear side of the seat back is contoured for accommodating a child lying down thereon.

According to another aspect, a vehicle seat back assembly includes a seat back for pivotally connecting to a vehicle seat base and adapted for movement between an upright position and a fold-down position wherein the seat back folds generally flat against the vehicle seat base. The vehicle seat back assembly further includes a hinged panel pivotally attached to a rear side of the seat back. The hinged panel is moveable to an open position when the seat back is in the fold-down position wherein an inner side of the hinged panel faces upward to provide an extended support surface for a child lying on the rear side of the seat back.

According to a further aspect, a vehicle includes a seat base and a folding seat back pivotally connected to the seat base. The folding seat back includes at least one of a contoured rear surface for retaining a child lying thereon when the seat back is folded onto the seat base in a fold-down position and a hinged panel pivotally attached to a rear side of the seat back that is moveable to an open position wherein an inner side of the hinged panel faces upward to provide an extended support surface for a child lying on the rear side of the seat back.

### BRIEF DESCRIPTION OF THE DRAWINGS

FIG. 1 is a perspective view of a vehicle seat assembly according to an exemplary embodiment including a seat base and a seat back pivotally connected to the seat base with a rear side of the seat back contoured for accommodating a child lying down thereon.

FIG. 2 is a perspective view of the vehicle seat assembly of FIG. 1 showing the seat back in a fold-down position with a child shown lying on the rear side of the seat back.

FIG. 3 is a partial rear elevational view (partially in cross section) of the vehicle seat assembly of FIG. 1 showing the seat back in an upright position with accessory items shown stowed in a seat pocket of the seat back.

FIG. 4 is a partial side elevation view (partially in cross section) of the vehicle seat assembly of FIG. 1.

FIG. 5 is a perspective view of a vehicle seat assembly according to another exemplary embodiment including a seat base and a seat back pivotally connected to the seat base with a hinged panel pivotally attached to a rear side of the seat back.

FIG. 6 is a side elevation view of the vehicle seat assembly of FIG. 5 showing the hinged panel in a closed position.

FIG. 7 is another side elevation view of the vehicle seat assembly similar to FIG. 6, but showing the hinged panel in a partially open position.

FIG. 8 is still another side elevation view of the vehicle seat assembly also similar to FIG. 6, but showing the seat back in a fold-down position.

FIG. 9 is still another side elevation view of the vehicle seat assembly similar to FIG. 8 but showing the hinged panel in an open position to provide an extended support surface for a child lying on the rear side of the seat back.

FIG. 10 is a partial cross sectional view taken along the line 10-10 of FIG. 7.

FIG. 11 is a cross sectional view similar to FIG. 10 but showing the hinged panel, and particularly a latching member thereof, unlatched from the seat back.

FIG. 12 is a perspective view of a vehicle seat assembly according to a further exemplary embodiment including a seat base and a seat back pivotally connected to the seat base with upper and lower hinged panels attached to the seat back.

FIG. 13 is a side elevation view of the vehicle seat assembly of FIG. 12 showing the seat back in an upright position.

FIG. 14 is a side elevation view of the vehicle seat assembly similar to FIG. 13, but showing the seat back in a fold-down position.

FIG. 15 is a side elevation view of the vehicle seat assembly similar to FIG. 14, but showing the upper and lower hinged panels in respective open positions to provide an extended support surface for a child lying on the seat back.

FIG. 16 is a top plan view of the vehicle seat assembly in the same positions as shown in FIG. 15 (i.e., seat back in fold-down position and upper and lower hinged panels in open positions).

FIG. 17 is a side elevation view of a vehicle seat assembly according to still another exemplary embodiment.

FIG. 18 is a cross sectional view taken along the line 18-18 of FIG. 17.

### DETAILED DESCRIPTION

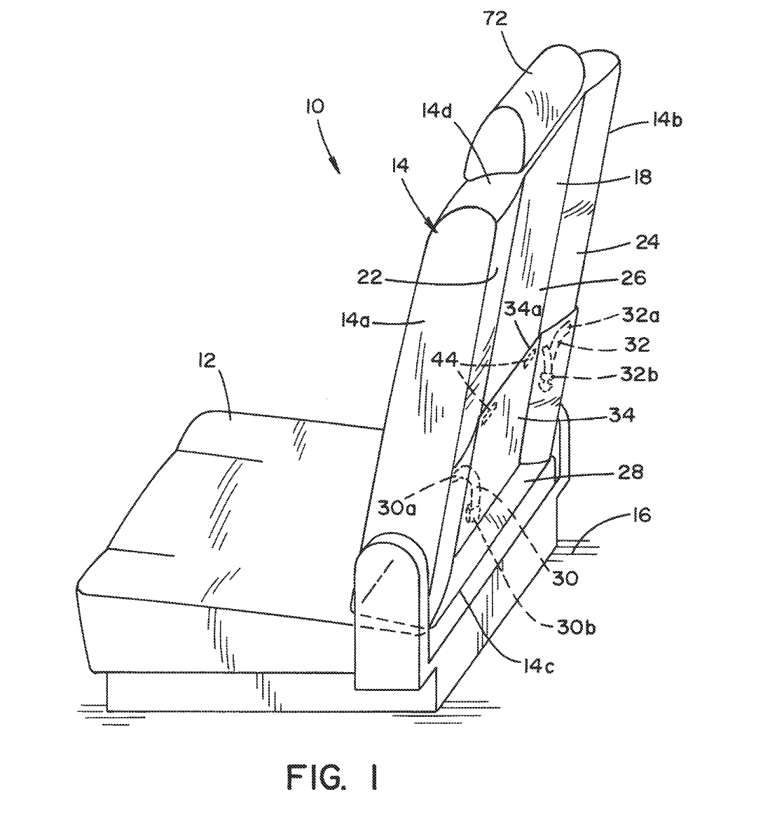

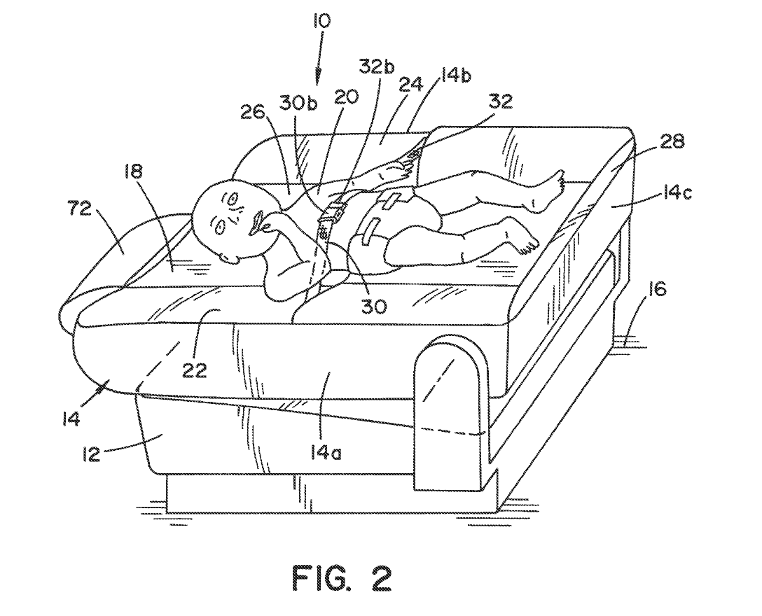

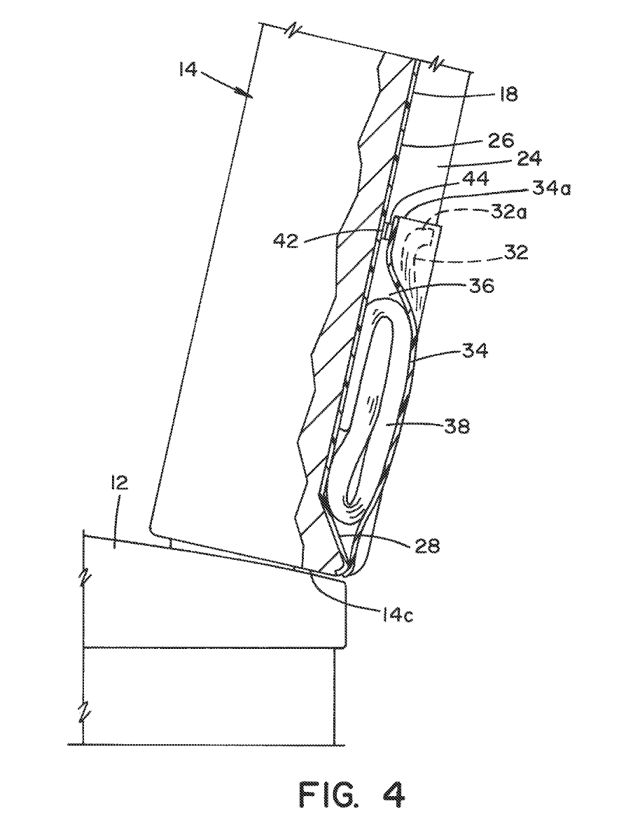

Referring now to the drawings wherein the showings are for purposes of illustrating one or more exemplary embodiments and not for purposes of limited the same, FIG. 1-4 illustrate a vehicle seat assembly 10 including a seat base 12 and a folding seat back 14 pivotally connected to the seat base 12. In particular, the seat base 12 can be disposed within a vehicle 16 and the seat back 14 can be adapted for movement between an upright position (shown in FIG. 1) and a fold-down position (shown in FIG. 2) wherein the seat back 14 folds generally flat against the seat base 12. More particularly, the seat back 14 is pivotally connected to the seat base 12 for movement between the upright position in which the seat base 12 and the seat back 14 are configured for accommodating a seated occupant and the fold-down position shown in FIG. 2 wherein the seat back 14 is folded down onto the seat base 12 with a rear side 18 of the seat back 14 facing upward (e.g., upward relative to a height dimension of the vehicle 16 in which the vehicle seat assembly 10 is disposed). As shown, the seat back 14 is in a generally horizontal orientation (i.e., disposed in a generally parallel plane) when in the fold down position. The seat back 14 can additionally include a head rest 72 movably secured to an upper side 14d of the seat back 14

The seat back 14, and particularly a rear side 18 of the seat back 14 (i.e., the side that faces rearwardly in the vehicle 16 when the seat back 14 is in the upright position), can be contoured for accommodating a child lying down thereon (e.g., illustrated child 20 in FIG. 2) when the seat back is in the fold-down position. In the embodiment illustrated in FIGS. 1-4, the rear side 18 (which can be referred to as a contoured rear side or a contoured rear surface) includes raised portions 22, 24 defined on the seat back 14 for retaining a child lying thereon (e.g., child 20) when the seat back 14 is folded onto the seat base 12 in the fold-down position. By this arrangement, the rear side 18 , which can also be referred to as a bolstered rear side or surface, is adapted to retain a child lying thereon when the seat back 14 is folded into a collapsed position on the seat base 12 and inhibit the child from rolling off the seat back 14. This advantageously gives the flexibility to the location of the person changing the child (e.g., the child can be changed while the changing person is standing outside the vehicle with the door open, while the changing person is in the car without the need for a door to be open, etc.).

In particular, in the embodiment illustrated in FIGS. 1-4, the raised portions 22, 24 are raised lateral bolsters or bolster portions that are disposed adjacent lateral sides 14a, 14b of the seat back 14 for reducing the likelihood of a child lying thereon from rolling off the seat back 14, such as when being changed (e.g., a baby getting his or her diaper changed). In addition or in the alternative, the seat back 18 can include a depressed central area 26 for receiving a child lying thereon. In the illustrated embodiment, the depressed central area 26 is defined between the raised portions 22, 24. The depressed central area 26 can be an actual depression into the rear side 18 of the seat back 14 (e.g., a recess defined into the rear side 18) and/or can be depressed relative to the raised portions 22, 24. Also in addition or in the alternative, the rear side 18 of the seat back 14 can include a raised portion 28 disposed along a lower side 14c of the seat back 14. The raised portion 28 can function as described hereinabove in regard to the raised portions 22, 24 to inhibit a child lying on the seat back 14 from rolling or otherwise falling off the seat back 14.

The vehicle seat assembly 10 of FIGS. 1-4 can further include a set of adjustable restraining straps 30, 32 having proximal ends 30a, 32a fixedly secured to the seat back 14 and distal ends 30b, 32b configured for removably latching to one another as is known and understood by those skilled in the art. As shown in FIG. 2, the distal ends 30b, 32b of the restraining straps 30, 32 can be latched to one another to secure the child 20 to the rear side 18 of the seat back 14 and further inhibit (i.e., an addition to the raised portions 22, 24 and 28 and the depressed central area 26) a child from inadvertently rolling off the seat back 14. As is also known and understood by those skilled in the art, the restraining straps 30, 32 can be adjustable restraining straps to accommodate child of varying sizes.

The vehicle seat assembly 10 of FIGS. 1-4 can further include a seat back pocket member 34 defining a seat back pocket 36 for accommodating stowed items (e.g., a changing pad or blanket 38 and a container of changing wipes 40). In one embodiment, the seat back pocket member 34 is a flexible material or fabric that generally rests flatly or tautly against the rear side 18 of the seat back 14 unless and until stowed articles are received in the seat back pocket 36. A fastening assembly 42, 44 can be provided that removably secures and closes the seat back pocket 36 by fastening an upper end 34a of the seat back pocket member 34 to the rear side 18 of the seat back 14 to retain the stowed items (e.g., stowed items 38 and 40) within the seat back pocket 36. In the illustrated embodiment, the fastening assembly 42, 44 comprises hook and loop fastener elements 42 and 44 disposed, respectively, on the seat back pocket member 34 adjacent the upper end 34a thereof and on the rear side 18 of the seat back 14 at corresponding locations. It is to be appreciated that other fastening assemblies could be used, such as snap-type fasteners, zippered fasteners, etc.

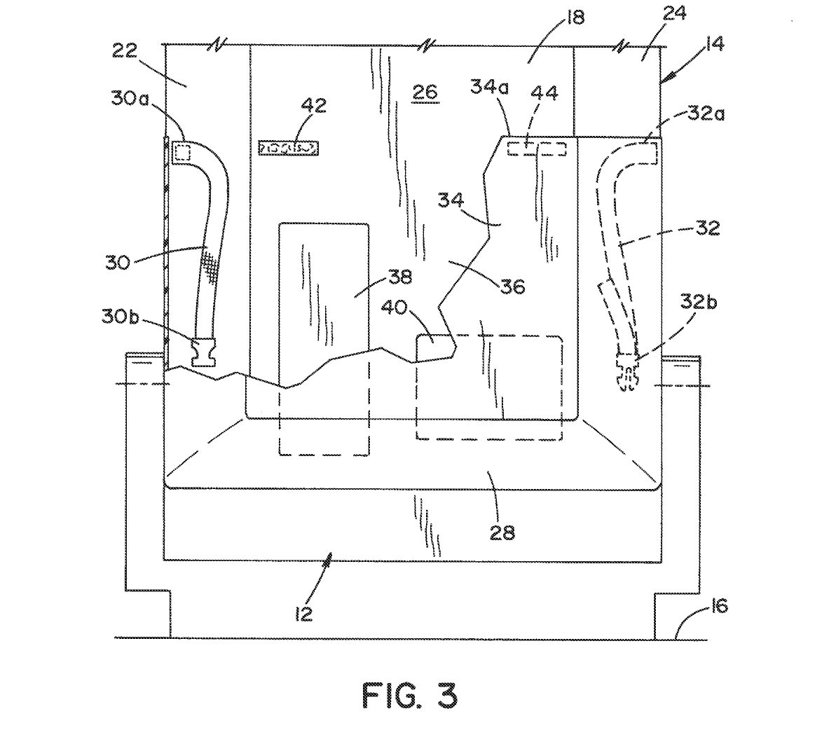

Advantageously, the restraining straps 30, 32 can be arranged for storage within the seat back pocket 36 when not in use. In particular, the proximal ends 30a, 32a of the restraining straps 30, 32 can be fixedly secured to the seat back 14 at locations within the seat back pocket 36 as shown best in FIG. 3. This allows the restraining straps 30, 32 to be stowed within the seat back pocket 36 when not in use but easily accessible and available when desired to secure the child 20 to the seat back 14 as shown in FIG. 2, thereby improving the aesthetics of the seat back 14 (e.g., no straps dangling from the seat back 14 when not in use).

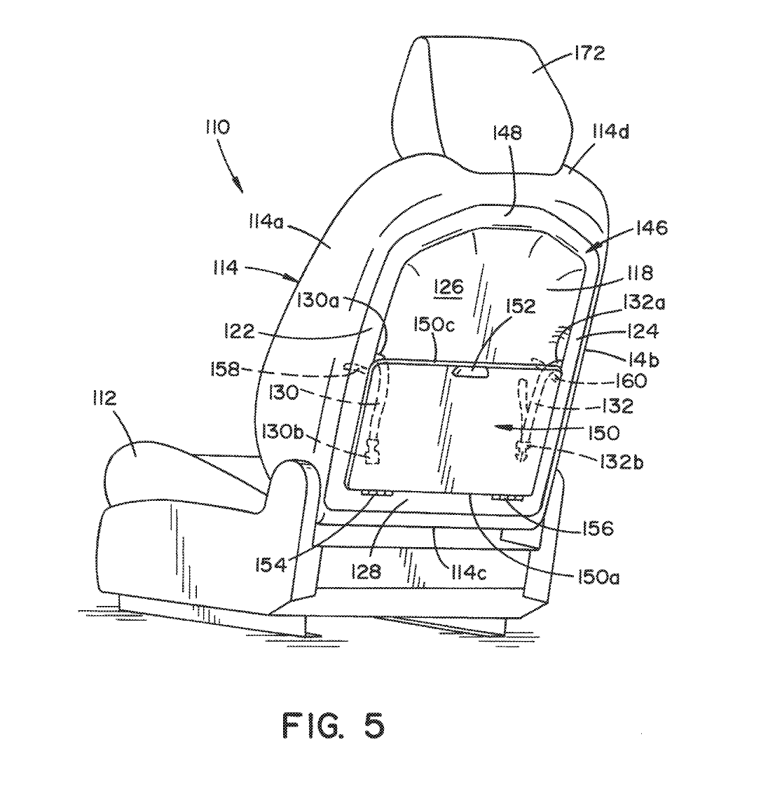

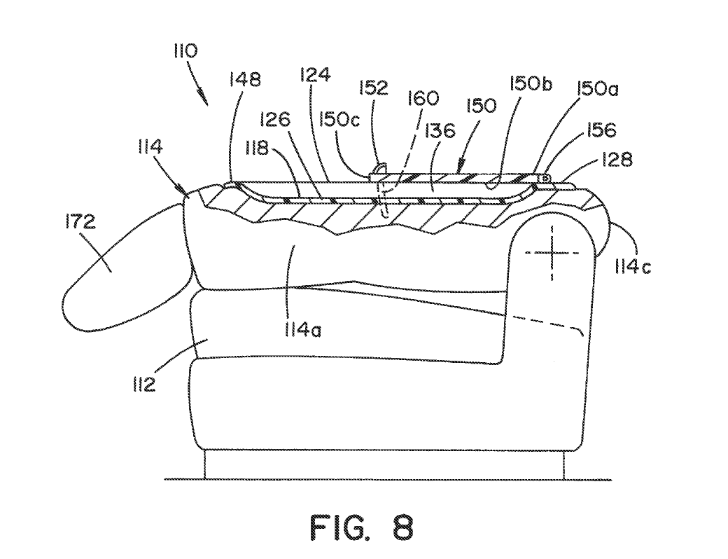

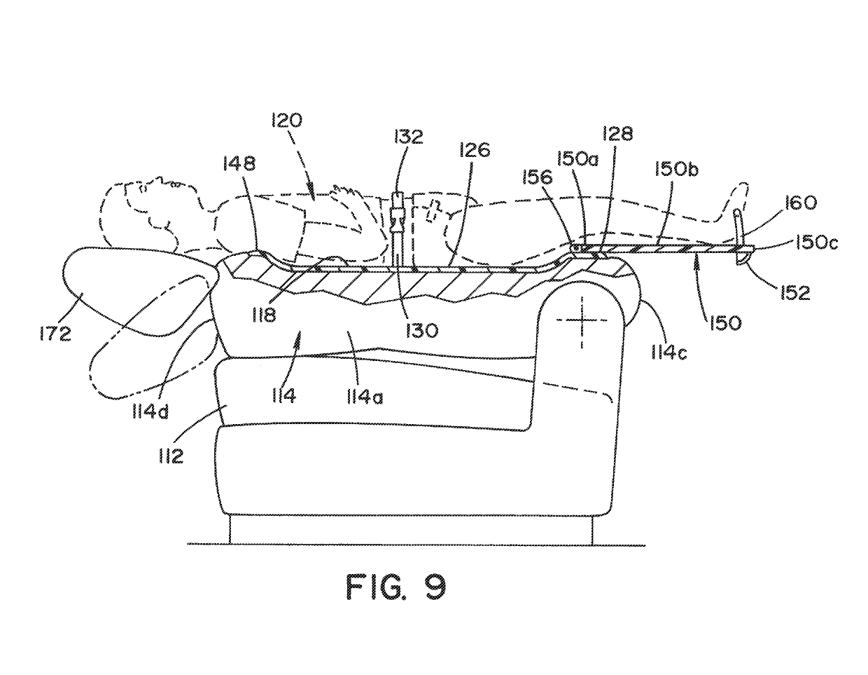

With reference now to FIGS. 5-9, a vehicle seat assembly 110 will be described according to an alternate exemplary embodiment. The seat assembly 110 can be generally the same as the seat assembly 10 of FIGS. 1-4 except as noted hereinbelow. In particular, the seat assembly 110 can include a seat base 112 and a seat back 114 pivotally connected to the seat base 112 for movement between an upright position (the position shown in FIGS. 5-7) in which the seat base 112 and the seat back 114 are configured for accommodating a seated occupant and a fold-down position (the position shown in FIGS. 8 and 9) wherein the seat back 114 is folded down onto the seat base 112 with a rear side 118 of the seat back 114 facing upward. The seat back 114, and particularly the rear side 118 thereof, can be contoured for accommodating a child lying down thereon (e.g., child 120 shown in FIG. 9) when the seat back 114 is in the fold-down position.

More specifically, the seat back 114, and particularly the rear side 118, can include a raised portion or portions defined thereon for retaining a child lying on the seat back 114 when the seat back 114 is folded onto the seat base 112 in the fold-down position. More particularly, the rear side 118 of the seat back 114 can include a raised perimeter 146 defining a depressed central area 126 for receiving a child lying down thereon. Like the raised portions 22, 24, 28, the raised perimeter 146 can include raised portions or lateral bolsters 122, 124 disposed adjacent lateral sides 114a, 114b of the seat back 114 and a raised portion or lower bolster 128 disposed adjacent a lower side 114c of the seat back 114. Additionally, the raised perimeter 146 can include a raised upper portion or bolster 148 spaced apart from the raised lower portion 128 and spanning between the raised portions 122, 124 thereby providing a fully enclosed raised perimeter 146, though this is not required and other configurations could be used.

In the illustrated embodiment, the raised perimeter 146 formed of the raised portions 122, 124 and 128 and the depressed central area 126 can be formed of an integrally and secured to the seat back 114 as an integrated vehicle component, though this is not required. Also, and like the vehicle seat assembly 10, any combination of the raised portions 122, 124 and 128 and the depressed central area 126 could be employed on the seat back 114. Further, the raised perimeter 146 and the depressed central area 126 (or any combination of the raised portions 122, 124 and 128 and the depressed central area 126) could alternately be applied to the seat back 14 of FIGS. 1-4. Likewise, the raised portions 22, 24 and 28 and/or the depressed central area 26 (or any combination of these elements) could be applied and/or substituted onto the seat back 114 of FIGS. 5-9.

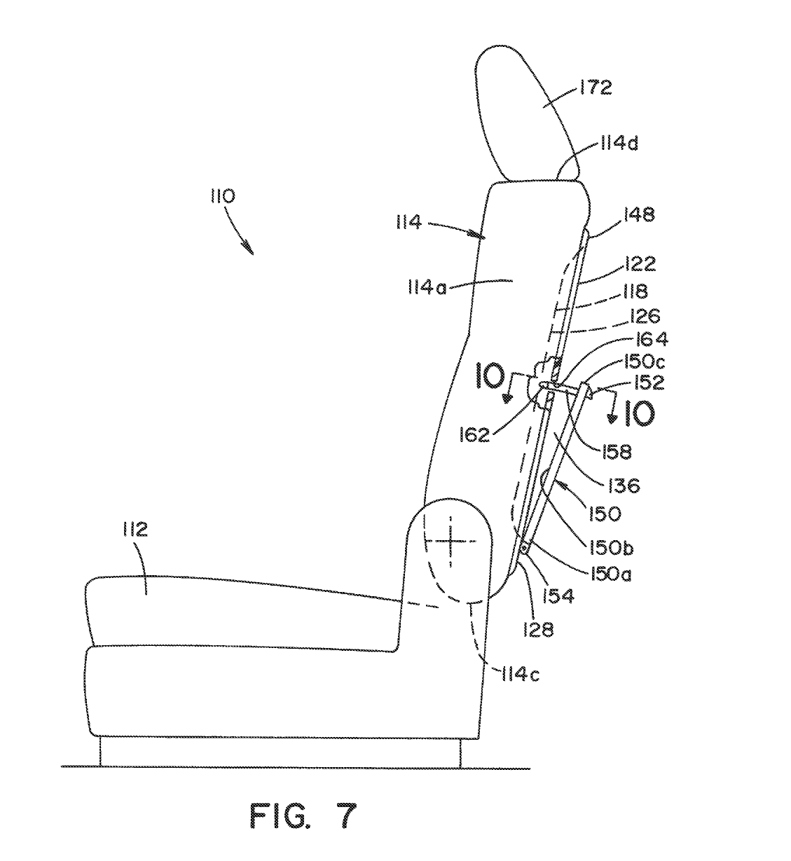

As shown, the vehicle seat assembly 110 can also include a hinged panel 150 pivotally attached to the rear side 118 of the seat back 114. In the illustrated embodiment, the seat assembly 110 includes both the rear side 118 being contoured and the hinged panel 150, though this is not required the seat back 114 could alternately be configured to include only one of these features (e.g., the seat back 114 could include a contoured rear side without a hinged panel or could include a hinged panel 150 without the rear side 118 being contoured). The hinged panel 150 is moveable to a partially open position (the position shown in FIG. 7) to define and/or access a seat back pocket 136 between the hinged panel 150 and the rear side 118 of the seat back 114. Though not shown, it is to be appreciated by those skilled in the art that the hinged panel 150 could optionally be applied to the vehicle seat assembly 10 of FIGS. 1-4.

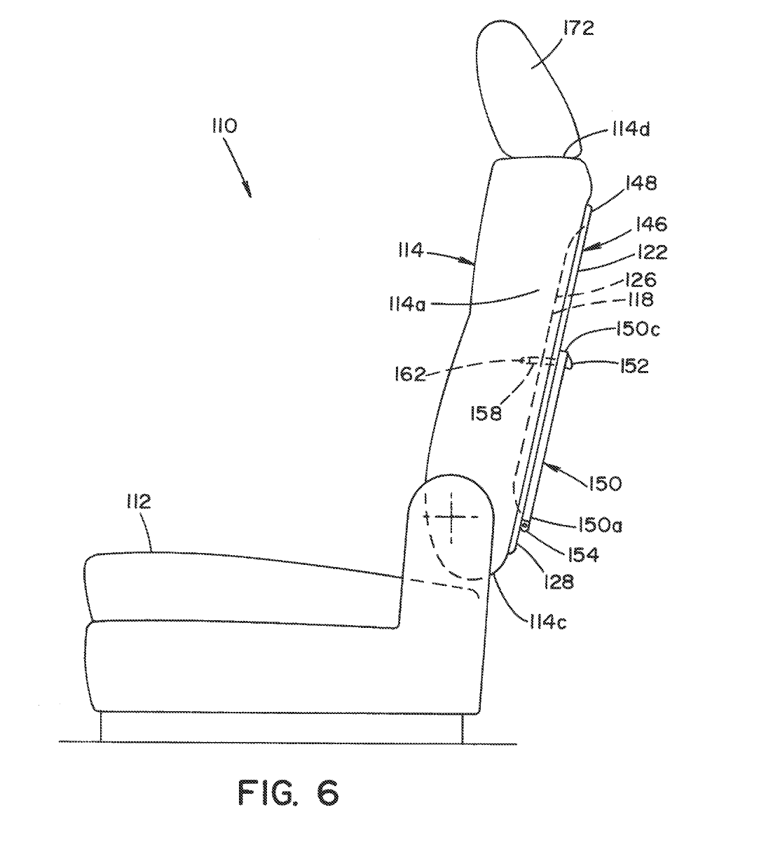

The hinged panel 150 can include a handle 152 for grasping the hinged panel 150 and moving the hinged panel from the closed position illustrated in FIGS. 5-6 to the partially open position illustrated in FIG. 7, and further to an open or fully open position illustrated in FIG. 9. As shown, the hinged panel 150 can include at least one hinge (e.g., hinges 154, 156 in the illustrated embodiment) pivotally securing a lower end 150a of the hinged panel 150 adjacent the lower side 114c of the seat back 114. As best shown in FIG. 9, the hinged panel 150 is moveable to an open position (also referred to as a fully open position) wherein an inner side 150b of the hinged panel 150 faces upward when the seat back 114 is in the fold-down position to provide an extended support surface for a child (e.g., child 120 shown in FIG. 9) lying on the rear side 118 of the seat back 114.

The seat assembly 110 can also include a set of adjustable restraining straps 130, 132 having proximal ends 130a, 132a fixedly secured to the seat back 118 and distal ends 130b, 132b configured for removeably latching to one another. Advantageously, the proximal ends 130a, 132a can be fixedly secured to the seat back 118 at locations within the seat back pocket 136 (i.e., or at least disposed below an upper end 150c of the hinged panel 150). As best shown in FIG. 5, this arrangement can function to hide the restraining straps 130, 132 when not in use but permits the restraining straps 130, 132 to be readily available and accessible when used to secure a child to the rear side 118 of the seat back 114 as shown in FIG. 9. The restraining straps 130, 132 can be otherwise like the restraining straps 30, 32 of seat assembly 10, including being adjustable as is known and understood by those skilled in the art.

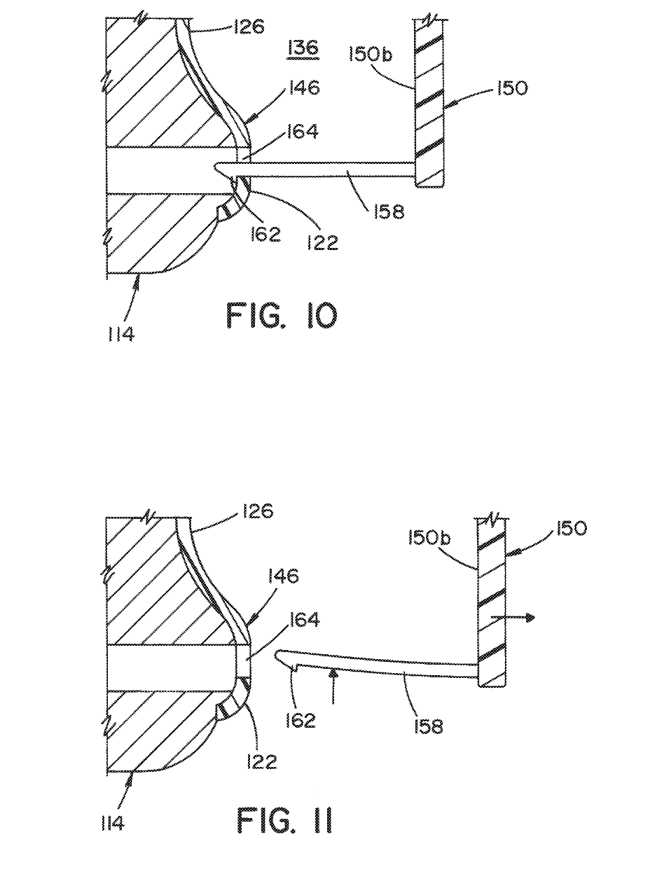

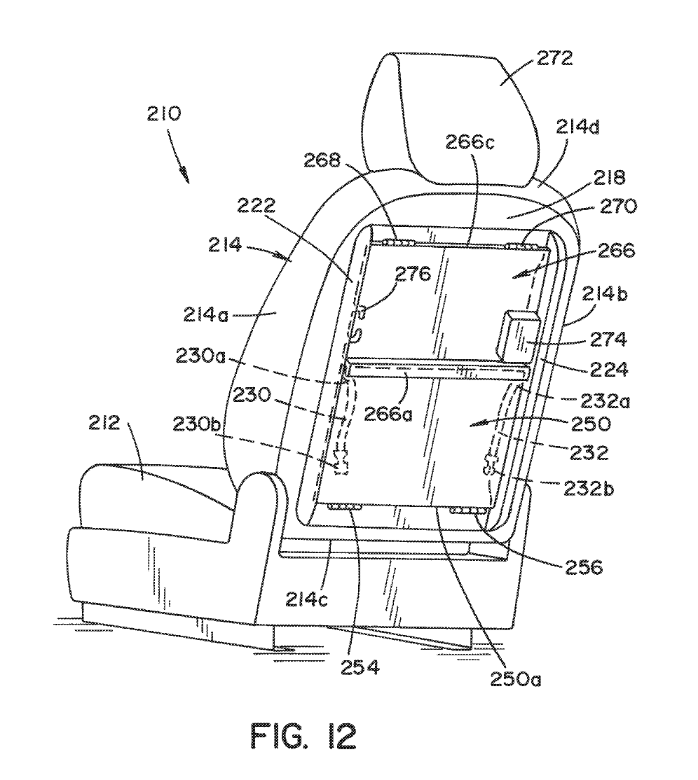

Additionally, the hinged panel 150 can include latching members 158, 160 protruding from the inner side 150b of the hinged panel 150 at laterally spaced locations thereon. With additional reference to FIGS. 10 and 11, each of the latching members 158, 160 (only latching member 158 shown in FIGS. 10 and 11) can include a barbed distal end 162 for retaining the hinged panel 150 in the partially open position and each of the latching members 158, 160 can be resiliently arranged such that an external force applied thereto (e.g., a laterally inboard force as shown by the arrow in FIG. 11) unlatches the latching members 158, 160 from the seat back 114 to allow the hinged panel 150 to be moved from the partially open position (the position shown in FIG. 7) toward the full open position (the position shown in FIG. 9) wherein the inner side 150b of the hinged panel 150 faces upward to provide an additional support surface supplemental to the rear side 118 of the seat back 114.

More particularly, the barbed distal end 162 can function to limit movement of the hinged panel 150 away from the seat back 114 when the handle 152 is pulled (i.e., prevent movement of the hinged panel 150 from going beyond the partially open position). However, upon application of the inboard lateral force to each of the latching members 158, 160, the barbed distal end 162 releases and the hinged panel 150 can be rotated via the hinges 154, 156 to the fully open position shown in FIG. 9. The hinged panel 150 can subsequently be returned to the partially open position by inserting the barbed distal end 162 of each of the latching members 158, 160 in the corresponding aperture (only aperture 164 shown) into the seat back 114 and, if desired, can be moved to the closed position wherein the latching members 158, 160 are fully received within their respective apertures (e.g., aperture 164).

Though not shown, an additional fastening assembly or device can be used to retain the hinged panel 150 in the fully closed position. For example, the additional fastening assembly can include one or more hook and loop fasteners (e.g., using hook and loop fastener elements like fastener elements 42, 44), magnetic fasteners, etc. to secure the hinged panel 150 in the fully closed position until desired to move the one of the open positions. Due to the depressed central area 126, such an additional fastening assembly may need to have its fastening element located adjacent lateral sides of the seat back 114 and the hinged panel 150.

A headrest 172 can be secured to the seat back 114 at the upper end 114d thereof. The headrest 172 can be reversible so that the headrest 172 can be normally in a forward seated passenger support position (i.e., the position shown in FIGS. 5-8 and in phantom in FIG. 9) but can be reversed to a child support position (i.e., the position shown in solid lines in FIG. 9) for supporting a child lying on the seat back 114 (e.g., the child 120). To reverse the headrest 172, in one embodiment, the headrest 172 is removed from the seat back 114, rotated one hundred and eighty degrees and then reinstalled into the seat back 114 in the reversed position. In the child support position, the head rest 172 is in an elevated position wherein the headrest 172 is elevated relative to the rear side 118 of the seat back 114 for providing support to a child lying thereon.

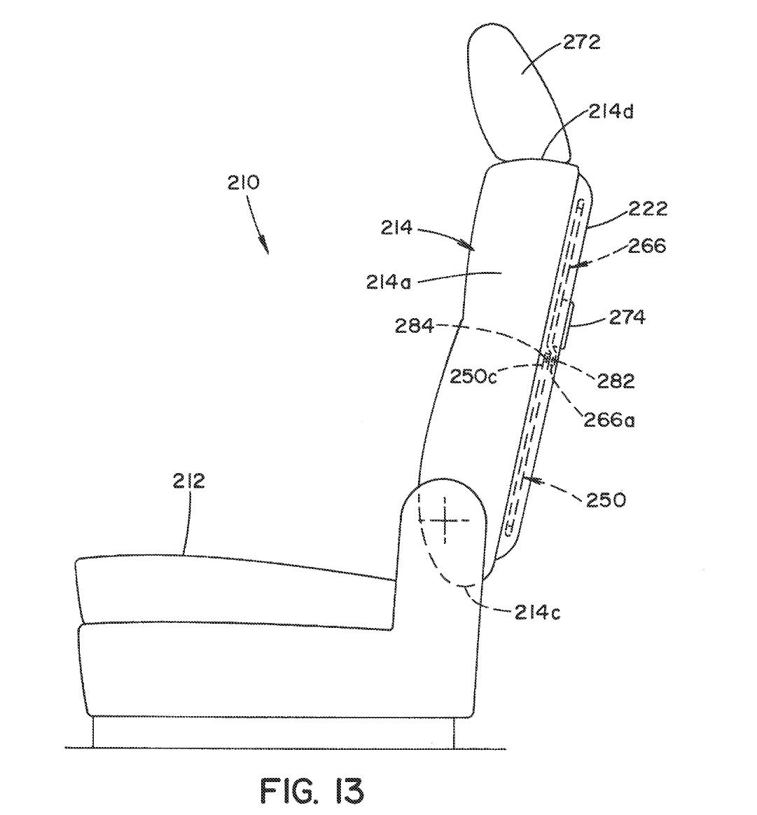

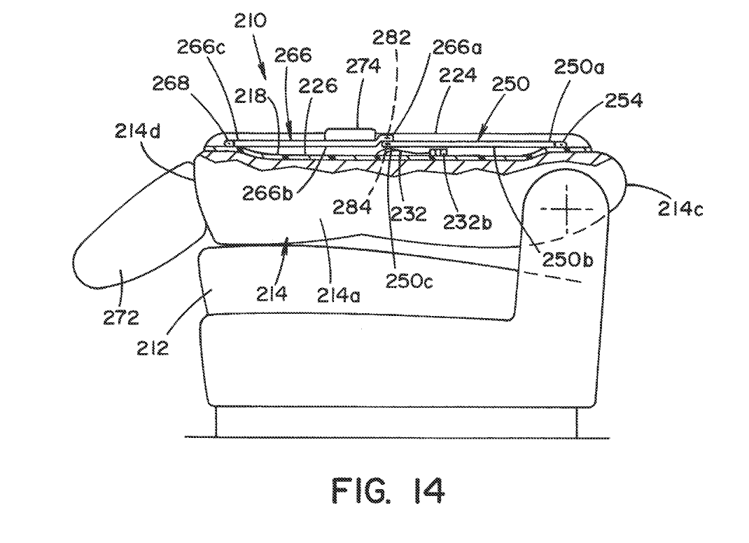

With reference now to FIGS. 12-16, a vehicle seat assembly 210 will be described according to another alternate exemplary embodiment. The seat assembly 210 can be generally the same as the seat assemblies 10 and 110 except as noted hereinbelow. In particular, the seat assembly 210 can include a seat base 212 and a seat back 214 pivotally connected to the seat base 212 for movement between an upright position (the position shown in FIGS. 12 and 13) in which the seat base 212 and the seat back 214 are configured for accommodating a seated occupant and a fold-down position (the position shown in FIGS. 14-16) wherein the seat back 214 is folded down onto the seat base 212 with a rear side 218 of the seat back 214 facing upward. The seat back 214 can additionally include a head rest 272 movably secured to an upper side 214d of the seat back 214

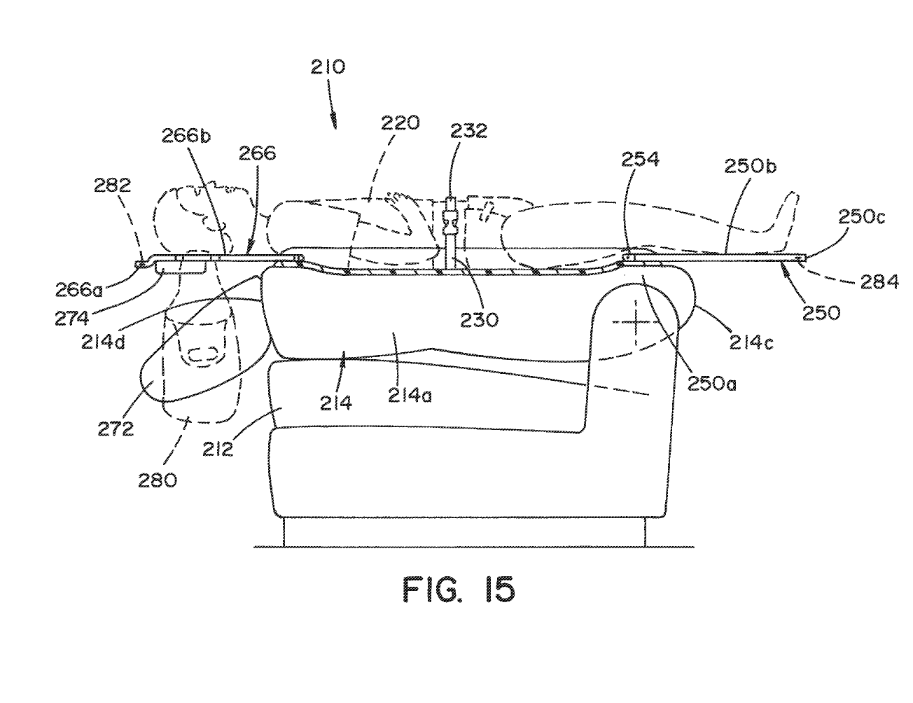

The seat back 214, and particularly the rear side 218 thereof, can be contoured for accommodating a child lying down thereon (e.g., child 220 shown in FIG. 15) when the seat back 214 is in the fold-down position. More specifically, the seat back 214, and particularly the rear side 218, can include raised portions 222, 224 defined thereon for retaining a child lying on the seat back 214 when the seat back 214 is folded onto the seat base 212 in the fold-down position. In particular, the raised portions 222, 224 can be lateral bolsters disposed adjacent lateral sides 214a, 214b of the seat back 214. The rear side 218 can also include a depressed central area 226 disposed between the raised portions 222, 224. In the illustrated embodiment, the raised portions 222, 224 and the depressed central area 226 can be formed of an integrally and secured to the seat back 214 as an integrated vehicle component, though this is not required. Also, and like the vehicle seat assemblies 10 and 110, any combination of the raised portions 222, 224 and the depressed central area 226 could be employed on the seat back 214. Further, the raised portions 222, 224 and the depressed central area 226 (or any combination of the raised portions 222, 224 and the depressed central area 226) could alternately be applied to either of the seat backs 14 or 114. Likewise, the raised portions and/or depressed central areas (or any combination of these elements) from the seat backs 14 and 114 could be applied and/or substituted onto the seat back 214 of FIGS. 12-16.

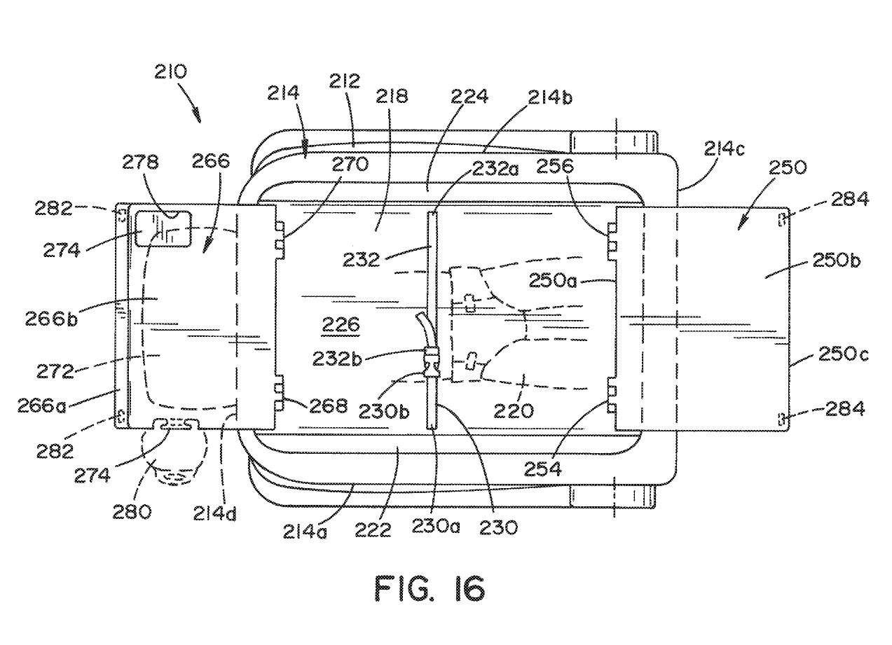

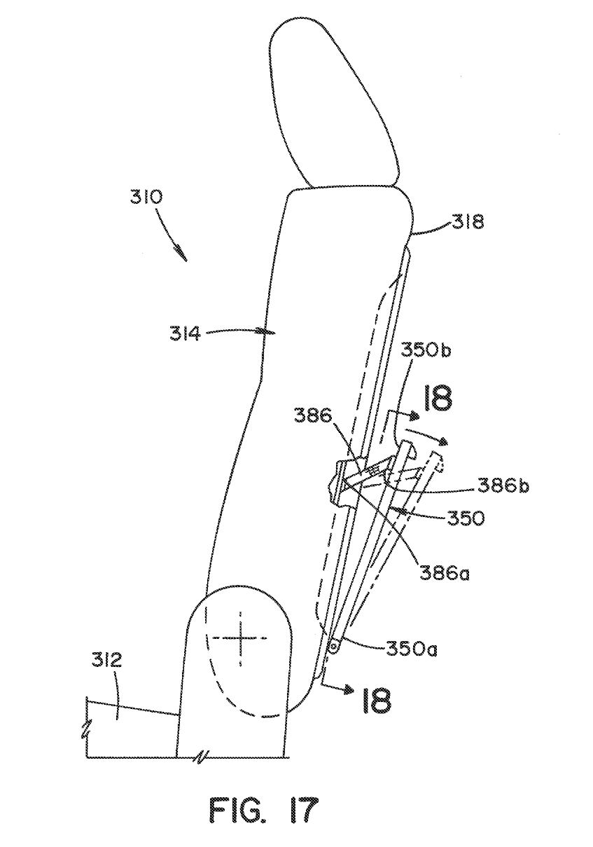

As shown, the vehicle seat assembly 210 can also include a hinged panel 250 pivotally attached to the rear side 218 of the seat back 214. The hinged panel 250 is moveable between a closed position (the position shown in FIGS. 12-14) and an open position (the position shown in FIGS. 15-16). As shown, the hinged panel 250 can include at least one hinge (e.g., hinges 254, 256 in the illustrated embodiment) pivotally securing a lower end 250a of the hinged panel 250 adjacent a lower side 214c of the seat back 214. As best shown in FIGS. 15 and 16, the hinged panel 250 is moveable to an open position (also referred to as a fully open position) wherein an inner side 250b of the hinged panel 250 faces upward when the seat back 214 is in the fold-down position to provide an extended support surface for a child (e.g., child 220 shown in FIGS. 15 and 16) lying on the rear side 218 of the seat back 214.

In the embodiment illustrated in FIGS. 12-16, the hinged panel 250 is a lower hinged panel (i.e., the lower hinged panel 250 is positioned adjacent the lower side 214c of the seat back 214) and the vehicle seat assembly 210 additionally includes an upper hinged panel 266 (i.e., the upper hinged panel 266 is positioned adjacent an upper side 214d of the seat back 214). The upper hinged panel 266 includes at least one hinge (e.g., hinges 268, 270) securing an upper end 266c of the upper hinged panel 266 adjacent the upper end 214d of the seat back 214. As best shown in FIGS. 15 and 16, the upper hinged panel 266 is moveable to an open position (also referred to as a fully open position) wherein an inner side 266b of the hinged panel 266 faces upward when the seat back 214 is in the fold-down position to provide an extended support surface for a child (e.g., child 220 shown in FIGS. 15 and 16) lying on the rear side 218 of the seat back 214.

As best shown in FIGS. 15 and 16, the upper hinged panel 266 extends away and forward (e.g., toward a front of the vehicle) from the upper end 214d of the seat back 214 when the seat back 214 is in the fold-down position and the upper hinged panel 266 is in the open position. Similarly, the lower hinged panel 250 extends away and rearward (e.g., toward a rear of the vehicle) from the lower end 214c of the seat back 214 when the seat back 214 is in the fold-down position and the lower hinged panel 250 is in the open position. Thus, the lower and upper hinged panels 250, 266 fold away from one another when moved from their respective closed positions shown in FIG. 14 toward the open positions shown in FIGS. 15 and 16.

One of the lower hinged panel 250 and the upper hinged panel 266 can overlap the other of the lower hinged panel 250 and the upper hinged panel 266 when the lower and upper hinged panels 250, 266 are in respective closed positions. In the illustrated embodiment, the upper hinged panel 266 overlaps the lower hinged panel 250. In particular, a lower end 266a of the upper hinged panel 266 can have a rabbit configuration that overlaps an upper end 250c of the lower hinged panel 250. This provides improved aesthetics for the seat back 214 in that a clean look is presented on the rear side 218. Additionally, and though not shown, handles (e.g., similar to handle 152) could be provided on the hinged panels 250, 266. As shown schematically in FIGS. 13 and 15, magnet elements 282, 284 (e.g., one or more sets of two magnets or one magnet and one magnetic element) can be respectively provided along the lower end 266a of the upper hinged panel 266 and along the upper end 250c of the lower hinged panel 250 to retain the hinged panels 250, 266 in the closed positions, though other fastening elements could be used.

The seat assembly 210 can also include a set of adjustable restraining straps 230, 232 having proximal ends 230a, 232a fixedly secured to the seat back 218 and distal ends 230b, 232b configured for removably latching to one another.

Advantageously, the proximal ends 230a, 232a can be fixedly secured to the seat back 218 at locations disposed behind the lower and upper hinged panels 250, 266 (e.g., behind the lower hinged panel 250 in the illustrated embodiment). As best shown in FIG. 12, this arrangement can function to hide the restraining straps 230, 232 when not in use but permits the restraining straps 230, 232 to be readily available and accessible when used to secure a child to the rear side 218 of the seat back 214 as shown in FIGS. 15 and 16. The restraining straps 230, 232 can be otherwise like the restraining straps 30, 32 of seat assembly 10, including being adjustable as is known and understood by those skilled in the art.

In addition, as shown in the illustrated embodiment, the upper and lower hinged panels 250, 266 can include accessory features (e.g., an integral compartment 274 and an integrated hook 276), though this is not required. Particular to the illustrated embodiment, the upper hinged panel 266 includes the integral compartment 274 having an access aperture 278 that is exposed when the upper hinged panel 266 is folded to the full open position such that the inner side 266b of the upper hinged panel 266 faces upward. In one configuration as shown in FIG. 15, the integral compartment 274 and the access aperture 278 can be appropriately sized and/or configured to accommodate wet wipes (e.g., baby wipes).

In addition or in the alterative, the upper hinged panel 266 can include the integrated hook 276 that enables an accessory item 280 to hang from the upper hinged panel 266 when the seat back 214 is in the fold-down position and the upper hinged panel 266 is folded to the full open position such that the inner side 266b of the upper panel 266 faces upward. As will be understood and appreciated by those skilled in the art, additional accessory features can be provided in association or integral with the hinged panels 250, 266 and more generally to the seat back 214. Also, it should be appreciated that such features, including the integral compartment and the integrated hook could be provisioned on the hinged panel 150 on the vehicle seat assembly 110.

While the seat assembly 210 is shown with the rear side 218 being contoured and shown including both hinged panels 250 and 266, it is to be appreciated that this is not required. In alternate embodiments, the seat back 214 could be configured to include only one of these features or any combination of these features (e.g., the seat back 214 could include a contoured rear side without a hinged panel, could include hinged panel 250 or 266 alone or could include a contoured rear side with only one of the panels 250 or 266). Also, it is to be appreciated that any of these features could be applied to the vehicle seats 14 and 114 in alternate embodiments and the features of these seat assembly 14 and 114 could be applied to the seat assembly 214.

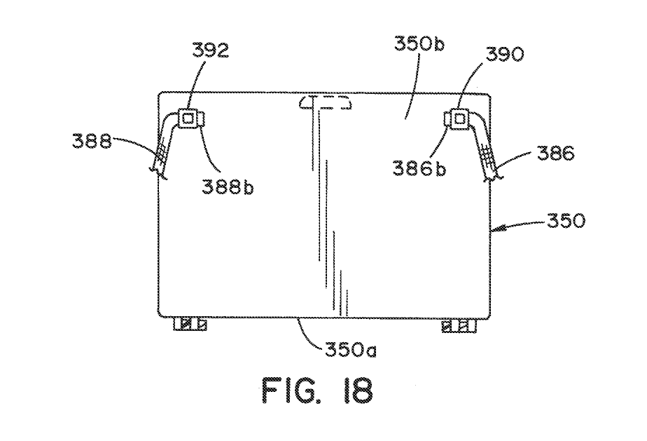

With reference to FIGS. 17 and 18, a vehicle seat assembly 310 will be described according to yet another alternate exemplary embodiment. The seat assembly 310 can be generally the same as the seat assembly 110 except as noted hereinbelow. In particular, the seat assembly 310 can include a seat base 312 and a seat back 314 pivotally connected to the seat base 312. The seat back 314, and particularly the rear side thereof 318, can be contoured for accommodating a child lying down thereon when the seat back 314 is in a fold-down position. The vehicle seat assembly 310 includes a hinged panel 350 pivotally attached along a lower side thereof 350a to the rear side 318 of the seat back 314. The hinged panel 350 is moveable among a generally closed position (the position shown in solid lines in FIG. 17), a partially open position (i.e., the position illustrated in phantom in FIG. 17) and a fold-open position (not shown, but like the position shown in FIG. 9 for the hinged panel 150).

Unlike the hinged panel 150, the hinged panel 350 is connected to the seat back 314 by elastic straps 386, 388 which normally retain and/or urge the hinged panel toward the closed position but are stretchable to enable the hinged panel 350 to be pulled against the urging of the elastic straps 386, 388 to the partially open position. Proximal ends (e.g., end 386a) of the elastic straps 386, 388 can be fixed to the seat back 314 and distal ends 386b, 388b of the elastic straps can be configured to be removably connected via buckle receivers 390, 392 to an inner side 350b of the hinged panel 350. The distal ends 386b, 388b and the buckle receivers 390, 392 can be configured so that pushing a release tab (not shown) unlatches the distal ends 386b, 388b from the buckle receivers 390, 392 and allows the hinged panel 350 to be pivoted to the open position. In other aspects, the hinged panel 350 can function like the hinged panel 150.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle seat assembly, comprising:
a seat base; and
a seat back pivotally connected to the seat base for movement between an upright position in which the seat base and seat back are configured for accommodating a seated occupant and a fold-down position wherein the seat back is folded down onto the seat base with a rear side of the seat back facing upward, the rear side of the seat back contoured for accommodating a child lying down thereon.

2. The vehicle seat assembly of claim 1 wherein the rear side of the seat back includes raised lateral bolsters disposed adjacent lateral sides of the seat back for reducing the likelihood of a child lying thereon from rolling off the seat back.

3. The vehicle seat assembly of claim 1 wherein the rear side of the seat back includes a depressed central area for receiving a child lying down thereon.

4. The vehicle seat assembly of claim 1 further including:
a set of adjustable restraining straps having proximal ends fixedly secured to the seat back and distal ends configured for removably latching to one another.

5. The vehicle seat assembly of claim 1 further including:
a seat back pocket member defining a seat back pocket for accommodating stowed items.

6. The vehicle seat assembly of claim 5 further including:
a fastening assembly that removably secures and closes the seat back pocket by fastening an upper end of the seat back pocket member to the rear side of the seat back to retain the stowed items within the seat back pocket.

7. The vehicle seat assembly of claim 1 further including:
a seat back pocket member defining a seat back pocket for accommodating stowed items; and
a set a adjustable restraining straps having proximal ends fixedly secured to the seat back at locations within the seat back pocket and distal ends configured for removably latching to one another.

8. The vehicle seat assembly of claim 1 wherein the rear side of the seat back includes a raised perimeter defining a depressed central area for receiving a child lying down thereon.

9. The vehicle seat assembly of claim 1 further including:
a hinged panel pivotally attached to the rear side of the seat back.

10. The vehicle seat assembly of claim 9 wherein the hinged panel is moveable to a partially open position to define a seat pocket between the hinged panel and the rear side of the seat back.

11. The vehicle seat assembly of claim 10 further including:
latching members protruding from an inner side of the hinged panel at laterally spaced locations thereon, each of the latching members including a barbed distal end for retaining the hinged panel in the partially open position and each of the latching members resiliently arranged such that an external force applied thereto unlatches the latching members from the seat back to allow the hinged panel to be moved from the partially open position toward the full open position wherein inner side of the hinged panel faces upward to provide an additional support surface supplemental to the rear side of the seat back.

12. The vehicle seat assembly of claim 9 wherein the hinged panel is moveable to an open position wherein an inner side of the hinged panel faces upward to provide an extended support surface for a child lying on the rear side of the seat back.

13. The vehicle seat assembly of claim 12 wherein the hinged panel is a lower hinged panel that includes at least one hinge pivotally securing a lower end of the lower hinged panel adjacent a lower side of the seat back, the lower hinged panel extending away from the lower end of the seat back when the seat back is in fold-down position and the lower hinged panel is in the open position.

14. The vehicle seat assembly of claim 13 further including:
an upper hinged panel that includes at least one hinge pivotally securing an upper end of the upper hinged panel adjacent an upper end of the seat back, the upper hinged panel extending away from the upper end of the seat back when the seat back is in the fold-down position and the upper hinged panel is in the open position.

15. The vehicle seat assembly of claim 14 wherein one of the lower hinged panel and the upper hinged panel overlaps the other of the lower hinged panel and the upper hinged panel when the lower and upper hinged panels are in respective closed positions.

16. The vehicle seat assembly of claim 9 wherein the hinged panel includes at least one of:
an integral compartment having an access aperture exposed when the hinged panel is folded to a full open position such that an inner side of the hinged panel faces upward; or
an integrated hook that enables an accessory item to hang from the hinged panel when the seat back is in the fold-down position and the hinged panel is folded to a full open position such that an inner side of the hinged panel faces upward.

17. The vehicle seat assembly of claim 9 further including:
elastic straps securing a distal end of the hinged panel to the seat back and urging the hinged panel toward a closed position, distal ends of the elastic straps removably connected to the hinged panel to enable the hinged panel to be moved to a full open position when the distal ends of the elastic straps are disconnected from the hinged panel.

18. A vehicle seat back assembly, comprising:
a seat back for pivotally connecting to a vehicle seat base and adapted for movement between an upright position and a fold-down position wherein the seat back folds generally flat against the vehicle seat base; and
a hinged panel pivotally attached to a rear side of the seat back, the hinged panel moveable to an open position when the seat back is in the fold-down position wherein an inner side of the hinged panel faces upward to provide an extended support surface for a child lying on the rear side of the seat back.

19. The vehicle seat back assembly of claim 18 wherein the rear side is a contoured rear surface including raised portions defined on the seat back for retaining the child lying thereon when the seat back is folded onto the vehicle seat base in the fold-down position.

20. A vehicle, comprising:
a seat base; and
a folding seat back pivotally connected to the seat base, the folding seat back including at least one of a contoured rear surface for retaining a child lying thereon when the seat back is folded onto the seat base in a fold-down position and a hinged panel pivotally attached to a rear side of the seat back that is moveable to an open position wherein an inner side of the hinged panel faces upward to provide an extended support surface for a child lying on the rear side of the seat back.
